(19) United States
(12) Patent Application Publication
(10) Pub. No.: US 2026/0366652 A1
(43) Pub. Date: Nov. 19, 2026

(54) PIPE FOR GUIDING REFRIGERANTS

(71) Applicant: TI Automotive (Fuldabrueck) GmbH, Fuldabrueck (DE)

(72) Inventors: Andre HAECKEL, Waldeck (DE); Martin SCHRAMOWSKI, Kassel (DE); Siegfried ARNOLD, Kassel (DE); Frank FAHRENHOLZ, Kassel (DE); Matthew STIEBER, Grosse Pointe, MI (US)

(21) Appl. No.: 19/133,839

(22) PCT Filed: Oct. 5, 2023
(86) PCT No.: PCT/EP2023/077510

§ 371 Date: Sep. 8, 2025

(30) Foreign Application Priority Data
Nov. 29, 2022 (DE) 20 2022 106 678.7

(51) Int. Cl. F16L 9/12; B32B 1/08; B32B 27/08; B32B 27/32; B32B 27/34; B60H 1/00; F25B 41/40

(52) U.S. Cl. CPC F16L 9/121; B60H 1/00571; B32B 1/08; B32B 27/08; B32B 27/32; B32B 27/34; B32B 2250/03; B32B 2250/24; B32B 2307/7376; B32B 2597/00; F25B 41/40

(57) ABSTRACT

A pipe for transporting refrigerants comprises a refrigerant barrier layer and a water barrier layer, wherein the water barrier layer surrounds the refrigerant barrier layer, and wherein the refrigerant barrier layer comprises a plastics material, in particular a thermoplastic plastics material. The water barrier layer has a polyolefin proportion of the least 45 or 60 or 75 or 90 wt. %.

### RELATED APPLICATIONS

The present disclosure claims priority to and is a national phase application of PCT Application PCT/EP2023/077510, filed Oct. 5, 2023, which claims the benefit of and priority to German Application 202022106678.7, filed on Nov. 29, 2022, the entire contents of each of which are incorporated herein by reference.

### FIELD

The present disclosure relates to a tube for transporting refrigerants, wherein the tube comprises a refrigerant barrier layer and a water barrier layer, wherein the water barrier layer surrounds the refrigerant barrier layer, wherein the refrigerant barrier layer comprises a plastic, in particular a thermoplastic. The present disclosure also relates to a use for this tube.

### BACKGROUND

A tube is known from EP 3 663 081 B1 and is used to guide a refrigerant for motor vehicle air conditioning systems and, in particular, to guide the refrigerant R-1234yf. For this purpose, the tube according to embodiment 3 comprises an outer PA 11 layer and an inner PA610 layer. The outer PA11 layer may be regarded as a water barrier layer. Similarly, the inner PA610 layer may be regarded as a refrigerant barrier layer.

However, we have found that the performance of automotive air conditioning systems with these polyamide tubes decreases over time. This was not observed to the same extent in otherwise identical air conditioning systems equipped with relatively expensive metal tubes or tubes with at least one metal layer.

### SUMMARY

The present disclosure provides a tube for transporting refrigerants which does not have a metal layer and yet maintains the performance of the air conditioning system as well as possible in the long term.

A tube for transporting refrigerants comprises a refrigerant barrier layer and a water barrier layer, wherein the water barrier layer surrounds the refrigerant barrier layer, wherein the refrigerant barrier layer comprises a plastic, in particular a thermoplastic, and wherein the water barrier layer has a polyolefin content of at least 45, 60, 75, or 90 wt %.

The present disclosure is based on the discovery that, due to the strong hygroscopicity of R-1234yf and other refrigerants, water is extracted from the air, causing the water to diffuse through the polyamide layers. This causes the polyamide layers to swell, reducing the inner diameter and thus the flow rate of the refrigerant. In addition, the refrigerant diffuses through the tube wall. Conversely, water penetrates into the tube lumen and dilutes the refrigerant. Due to these effects, the performance of the entire air conditioning system is noticeably reduced over time. The present disclosure is also based on the discovery that polyolefins provide a significantly better water barrier than polyamides. Unexpectedly it has been found that higher polyolefin contents in the water barrier layer reduce both swelling of the barrier layers and dilution of the refrigerant.

The present disclosure is also based on the discovery that refrigerant barrier layers are often waterproof but are impaired by water. As a result, the barrier properties of the refrigerant barrier layer deteriorate due to the adverse effects of water, allowing the refrigerant to escape more easily through the tube layers over time. Conversely, this also applies to the water barrier layer, which can be adversely affected by refrigerants and allows water to diffuse more easily over time. It has been found that, according to the present disclosure, it is preferable to provide a water barrier layer for sealing to the outside and a refrigerant barrier layer for sealing to the inside. This allows one barrier layer to relieve the other, thereby achieving particularly good shielding of the refrigerant and, as a result, reduces both swelling of the barrier layers and dilution of the refrigerant.

The tube conveniently has a tube wall. The tube wall advantageously encloses a lumen for transporting the refrigerant. Conveniently, the tube wall comprises the refrigerant barrier layer and the water barrier layer. The tube or tube wall may define a center axis, which determines an axial direction, a radial direction, and a circumferential direction. In the case of a bent tube, the directions defined by the center axis depend on the axial position.

The term “layer” preferably means that the material of the layer is homogeneously mixed. It is preferred that the layers are visible under a microscope by means of boundary transitions between the layers. Conveniently, the layers are mixed with each other in the region of the boundary transitions. Advantageously, the boundary transitions are not considered to be separate layers. Conveniently, a tube with n layers comprises n-1 boundary transitions between the layers.

The term “refrigerant” preferably refers to a fluid medium that absorbs heat at low temperature and low pressure in a refrigeration process and releases heat at higher temperature and higher pressure. Unlike a coolant, a refrigerant can remove heat energy in a refrigeration cycle, whereby the ambient temperature may even be higher than the temperature of the object to be cooled by using supplied energy (in particular compression). The refrigerant is preferably defined in accordance with DIN EN 378-1, section 3.7.1. The refrigerant can be a natural refrigerant or a synthetic refrigerant. Natural refrigerants include ammonia, carbon dioxide, water, hydrocarbons, and/or air. Synthetic refrigerants include, in particular, halogenated (chlorinated, brominated, and/or fluorinated) hydrocarbons. A well-known refrigerant is, for example, the refrigerant with the trade name R1234yf, which is also called 2,3,3,3-tetrafluoropropene and has the molecular formula C3H2F4. Like many other refrigerants, this refrigerant is gaseous at room temperature and is also flammable and toxic.

According to a preferred embodiment, the water barrier layer has a thickness of at least 0.2 or 0.3 or 0.4 mm. Advantageously, the thickness of the water barrier layer is at most 1.2 or 1.0 or 0.9 or 0.8 mm. The water barrier layer is preferably relatively thick so that the barrier effect against water is such that even after years, only a very small amount of water has passed through to the refrigerant barrier layer. As a result, due to the large thickness of the water barrier layer, the refrigerant barrier layer is not or at least hardly affected by water diffusion through the water barrier layer even after years.

It is preferred that the polyolefin content of the water barrier layer comprises a polypropylene. Preferably, the polyolefin content of the water barrier layer comprises only polypropylene. In principle, polyolefins other than polypropylene can also be considered, although these generally have lower melting temperatures. The melting temperature of polypropylene is therefore better suited to the preferred polymers of the other layers than other polyolefins. It is possible that the polyolefin content of the water barrier layer comprises several polyolefins. It is preferred that the water barrier layer comprises less than 55%, 40%, 25%, or 10%, and preferably no polyamide. The polyolefin or polypropylene is advantageously modified to improve impact strength. The polypropylene may be part of a blend. It is advantageous if the polypropylene of the water barrier layer or the polyolefin content of the water barrier layer is a component of a copolymer and preferably a block copolymer, wherein the block copolymer advantageously comprises polypropylene and ethylene. It is preferred that the water barrier layer is free of adhesion modifiers.

According to a preferred embodiment, the plastic of the refrigerant barrier layer comprises a vinyl alcohol plastic and/or a fluoropolymer. The vinyl alcohol plastic preferably comprises an ethylene-vinyl alcohol copolymer (EVOH), a polyvinyl alcohol (PVOH) and/or a butylene glycol-vinyl alcohol copolymer (BVOH). The vinyl alcohol plastic preferably comprises an EVOH. The EVOH of the refrigerant barrier layer or of the vinyl alcohol plastic advantageously has an ethylene content of at most 50, 45, 40, 36, 33, or 30 mol %, respectively. It is advantageous for the ethylene content of the refrigerant barrier layer or the EVOH to be at least 20 or 25 mol %. Vinyl alcohol plastics and fluoropolymers have been found to have a particularly good barrier effect against refrigerants. Vinyl alcohol plastics are characterized by low material costs and good processability, with EVOH proving particularly suitable in this regard. The impact modification of the vinyl alcohol plastic, in particular through the addition of ethylene, serves primarily to reduce the probability of breakage of the refrigerant barrier layer or the vinyl alcohol plastic. At the same time, the impact modification reduces the barrier properties, so that an EVOH with a relatively low ethylene content is particularly preferable. The low ethylene content results in good barrier effect and thus a relatively thin refrigerant barrier layer. However, the refrigerant barrier layer is relatively brittle due to the preferred, relatively low ethylene content.

It is preferred that the refrigerant barrier layer has a thickness of no more than 0.4 or 0.3 or 0.2 mm. Advantageously, the thickness of the refrigerant barrier layer is at least 0.04, 0.06, or 0.08 mm. It is preferred that the refrigerant barrier layer is relatively thin, whereby the tube wall of the tube can be designed to be relatively thin overall. This relatively low layer thickness is then advantageously combined with a relatively high barrier effect. Relatively thin layers, in particular relatively thin, brittle layers, have the advantage that they can be bent more easily than thicker and less brittle layers or refrigerant barrier layers.

According to a preferred embodiment, the refrigerant barrier layer surrounds a support layer, wherein the support layer preferably comprises a polymer, in particular a thermoplastic polymer, and more preferably a polyamide, in particular PA6. The refrigerant barrier layer advantageously adheres to the support layer. This is particularly advantageous if the refrigerant barrier layer comprises EVOH and PA6 is used as the support layer, since PA6 adheres well to EVOH. It is preferred that the support layer is at least 0.2 or 0.3 or 0.4 or 0.5 mm thick. It is advantageous for the thickness of the support layer to be no more than 1.0 or 0.9 or 0.8 or 0.7 mm. The advantage of a relatively thick support layer is that it protects the relatively brittle refrigerant barrier layer from mechanical stress and thus prevents cracks or breaks in particular. At the same time, the support layer mitigates the chemical influences of the refrigerant on the refrigerant barrier layer, so that even after years of operation, the refrigerant barrier layer is only exposed to small amounts of diffusing refrigerant that impair its barrier function.

It is particularly advantageous for the water barrier layer to be surrounded by a protective layer, which preferably comprises a polymer, in particular a thermoplastic polymer, and more preferably a polyamide, in particular PA12 and/or PA612. Advantageously, the thickness of the protective layer is at least 0.1 or 0.2 or 0.3 mm. Preferably, the thickness of the protective layer is at most 0.8 or 0.7 or 0.6 mm.

It is preferred that an inner adhesion promoter layer is arranged between the water barrier layer and the refrigerant barrier layer, wherein the inner adhesion promoter layer preferably comprises a polymer, more preferably a polyolefin and particularly preferably a polypropylene. Advantageously, the inner adhesion promoter layer comprises an adhesion modifier. The adhesion modifier may, for example, comprise maleic anhydride. Advantageously, the thickness of the inner adhesion promoter layer is at least 0.02, 0.03, or 0.04 mm, respectively. It is preferred that the thickness of the inner adhesion promoter layer is at most 0.2, 0.15, or 0.10 mm, respectively. Preferably, the inner adhesion promoter layer is located on the refrigerant barrier layer and/or on the water barrier layer.

According to a preferred embodiment, an outer adhesion promoter layer is arranged between the water barrier layer and the protective layer, wherein the outer adhesion promoter layer preferably comprises a polymer, more preferably a polyolefin and particularly preferably a polypropylene. Advantageously, the outer adhesion promoter layer comprises an adhesive modifier, which comprises, for example, maleic anhydride. Conveniently, the thickness of the outer adhesion promoter layer is at least 0.02, 0.03, or 0.04 mm, respectively. It is advantageous that the thickness of the outer adhesion promoter layer is at most 0.2, 0.15, or 0.10 mm, respectively. Advantageously, the outer adhesion promoter layer is located on the water barrier layer and/or on the protective layer.

A tube for transporting a refrigerant may be used in an air conditioning system, wherein the tube is designed according to the present disclosure, wherein the air conditioning system is advantageously arranged on a vehicle, in particular on a road vehicle, and most preferably on a passenger car or on a truck.

### DETAILED DESCRIPTION

The present disclosure is outlined below with reference to two embodiments.

In a first embodiment, the tube for transporting refrigerants preferably comprises six layers. According to the present disclosure, the tube of the first embodiment comprises a water barrier layer and a refrigerant barrier layer, wherein the water barrier layer preferably comprises polypropylene. The water barrier layer may have a layer thickness of 0.5 mm. Advantageously, the water barrier layer comprises a block copolymer, wherein the block copolymer conveniently comprises polypropylene and ethylene. The melting temperature of the water barrier layer may be, for example, 160 °C. The refrigerant barrier layer of the first embodiment may comprise a vinyl alcohol plastic in the form of EVOH. The EVOH of the refrigerant barrier layer advantageously has an ethylene content of 27 mol %. The layer thickness of the refrigerant barrier layer is preferably 0.1 mm.

Advantageously, the tube of the first embodiment comprises a support layer which is surrounded by the refrigerant barrier layer. In this embodiment, the support layer comprises PA6. Preferably, the support layer is adjacent to the refrigerant barrier layer. The support layer may have a layer thickness of 0.6 mm. The tube of the first embodiment advantageously has a protective layer which surrounds the water barrier layer. The protective layer of the first embodiment preferably comprises PA612 and has a layer thickness of, for example, 0.45 mm.

It is highly preferred that the tube of the first embodiment has an inner and/or an outer adhesion promoter layer. Preferably, an inner side of the water barrier layer is adjacent to the inner adhesion promoter layer. Advantageously, an outer side of the water barrier layer is adjacent to the outer adhesion promoter layer. In the first embodiment, the inner and outer adhesion promoter layers each comprise a polypropylene.

Preferably, the inner and outer adhesion promoter layers of the first embodiment comprise an adhesion modifier in the form of maleic anhydride. The adhesion modifier enables good adhesion of the adhesion promoter layers to the water barrier layer, the refrigerant barrier layer and the protective layer. The inner and outer adhesion promoter layers of the first embodiment each have a layer thickness of, for example, 0.05 mm.

The tube of the second embodiment is identical to the tube of the first embodiment with regard to the support layer, the refrigerant barrier layer, and the protective layer. However, the tube of the second embodiment does not have any adhesion promoter layers, so that the water barrier layer is in contact with the refrigerant barrier layer on the inside and with the protective layer on the outside. The water barrier layer of the second embodiment comprises an adhesion modifier, which may be, for example, maleic anhydride. However, due to the adhesion modifier, the barrier effect against water is somewhat lower. The water barrier layer of the second embodiment preferably has a layer thickness of 0.9 mm.

1. A tube for transporting refrigerants comprising:
a refrigerant barrier layer, wherein the refrigerant barrier layer comprises a thermoplastic; and
a water barrier layer, wherein the water barrier layer surrounds the refrigerant barrier layer;
wherein the water barrier layer has a polyolefin content of at least 45 or 60 or 75 or 90% by weight.

2. The tube according to claim 1, wherein the water barrier layer has a thickness of at least 0.2 mm.

3. The tube according to claim 1, wherein the polyolefin content of the water barrier layer comprises polypropylene.

4. The tube according to claim 1, wherein the plastic of the refrigerant barrier layer comprises a vinyl alcohol plastic and/or a fluoropolymer, wherein the vinyl alcohol plastic comprises an ethylene-vinyl alcohol copolymer (EVOH), a polyvinyl alcohol (PVOH) and/or a butene diol-vinyl alcohol copolymer (BVOH).

5. The tube according to claim 1, wherein the refrigerant barrier layer has a thickness of at most 0.4 mm.

6. The tube according to claim 1, wherein the refrigerant barrier layer surrounds a support layer, wherein the support layer comprises a polyamide.

7. The tube according to claim 1, wherein the water barrier layer is surrounded by a protective layer, wherein the protective layer comprises a polyamide.

8. The tube according to claim 17, wherein an inner adhesion promoter layer is arranged between the water barrier layer and the refrigerant barrier layer, wherein the inner adhesion promoter layer comprises a polyolefin.

9. The tube according to claim 7, wherein an outer adhesion promoter layer is arranged between the water barrier layer and the protective layer, wherein the outer adhesion promoter layer comprises a a polyolefin.

10. The use of a tube for transporting a refrigerant in an air conditioning system, wherein the tube is designed according to claim 1, wherein the air conditioning system is arranged on a road vehicle.

11. The tube according to claim 1, wherein the water barrier layer has a polyolefin content of at least 60% by weight.

12. The tube according to claim 1, wherein the water barrier layer has a polyolefin content of at least 75% by weight.

13. The tube according to claim 1, wherein the water barrier layer has a polyolefin content of at least 90% by weight.

14. The tube according to claim 1, wherein the water barrier layer has a thickness of at least 0.4 mm

15. The tube according to claim 1, wherein the refrigerant barrier layer has a thickness of at most 0.2 mm.

16. The tube according to claim 6, wherein the support layer comprises a PA6.

17. The tube according to claim 7, wherein the protective layer comprises PA12 and/or PA612.

18. The tube according to claim 8, wherein the inner adhesion promoter layer comprises a polypropylene.

19. The tube according to claim 9, wherein the outer adhesion promoter layer comprises a polypropylene.
